(19) United States
(12) Patent Application Publication
(10) Pub. No.: US 2005/0192882 A1
(43) Pub. Date: Sep. 1, 2005

(54) Method and system for structured finance using deferrable preferred securities

(76) Inventors: Matt Butler, London (GB); David Spivak, Jersey City, NJ (US); Stan Krutonogiy, Brooklyn, NY (US)

Correspondence Address: Chris L. Holm;Milbank, Tweed, Hadley & McCloy LLP, 1 Chase Manhattan Plaza, New York, NY, 10005, US

(21) Appl. No.: 11/054,454

(22) Filed: Feb. 9, 2005

Related U.S. Application Data
(60) Provisional application No. 60/543,455, filed on Feb. 9, 2004.

(51) Int. Cl. G06F 17/60

(52) U.S. Cl. 705/35

(57) ABSTRACT

The invention provides a system and method for structured finance wherein a company forms an entity Sub and capitalizes it with equity. The Sub purchases perpetual preferred shares that are issued by the company. The Sub issues notes which are purchased by investors. The company provides a financial guarantee of the notes.

This application claims priority to U.S. Provisional Patent Application Ser. No. 60/543,455, filed Feb. 9, 2004, entitled Deconsolidated Preferred Securities, the disclosure of which is incorporated herein by reference.

### BACKGROUND

The invention relates to the field of finance and more particularly to the field of structured finance.

To assist with raising funds or to provide capital, companies use a variety of methods, which may include structured finance transactions. Each of the known transactions has an associated tax and accounting consequence, that may not be optimal. What is needed are systems and methods to provide structured finance transactions that take better advantage of the tax and accounting consequences for a given transaction.

The preceding description is not to be construed as an admission that any of the description is prior art relative to the present invention.

### SUMMARY OF THE INVENTION

In one embodiment, the invention provides a system and method for structured finance wherein a company forms an entity, Sub (which may be a subsidiary or an affiliate or another relationship with respect to the company, and may take the form of a limited liability company, a trust, a business trust, a partnership or a number of other legal forms), and capitalizes it with equity. The Sub purchases perpetual preferred shares that are issued by the company. The Sub issues notes which are purchased by investors. The company provides a financial guarantee of the notes issued by the Sub.

In another embodiment, the invention provides a system and method for structured finance wherein a company forms an entity, Sub (which may be a subsidiary or an affiliate or another relationship with respect to the company, and may take the form of a limited liability company, a trust, a business trust, a partnership or a number of other legal forms), and capitalizes it with equity. The Sub issues notes to a newly formed Trust. The Trust issues trust certificates which are purchased by investors. The company provides a performance guarantee of the Trust to investors. The Sub purchases perpetual preferred shares that are issued by the company. The company provides a financial guarantee of the notes issued by the Sub.

In another embodiment, the invention provides a system and method for structured finance wherein a company forms an entity, Sub (which may be a subsidiary or an affiliate or another relationship with respect to the company, and may take the form of a limited liability company, a trust, a business trust, a partnership or a number of other legal forms), and capitalizes it with equity. The Sub issues notes to a newly formed Trust. The Trust issues preferred trust certificates which are purchased by investors. The company owns nominal common units of the Trust and provides a performance guarantee of the Trust to investors. The Sub purchases perpetual preferred shares that are issued by the company. The company provides a financial guarantee of the notes issued by the Sub.

In another embodiment, the invention provides a system and method for structured finance wherein the maturity of the notes can be up to forty-nine years.

In another embodiment, the invention provides a system and method for structured finance wherein the interest on the notes is payable periodically (e.g., monthly, quarterly, semi-annually or annually in arrears).

In another embodiment, the invention provides a system and method for structured finance wherein the notes can be callable after a certain period of time (e.g., five years) at par plus accrued and unpaid interest.

In another embodiment, the invention provides a system and method for structured finance wherein the guarantee of the notes provided by the company is a junior subordinated financial guarantee.

In another embodiment, the invention provides a system and method for structured finance wherein the perpetual preferred shares issued by the company and purchased by the Sub provide for cumulative dividends.

In another embodiment, the invention provides a system and method for structured finance wherein the perpetual preferred shares can be callable after a certain period of time (e.g., five years) at par plus accrued and unpaid dividends.

In another embodiment, the invention provides a system and method for structured finance wherein the interest payments on the notes may be suspended by the Sub for a period of time (e.g., up to a maximum of twenty consecutive quarters), provided that payments on all of the company shares and deferrable securities ranking pari passu or junior to the financial guarantee on the notes are likewise suspended.

In another embodiment, the invention provides a system and method for structured finance wherein during the allowable suspension period, the interest on the notes would accrue and compound.

In another embodiment, the invention provides a system and method for structured finance wherein after the Sub suspends interest payments on the notes for the maximum allowable period, the company can pay all accrued and unpaid dividends on the perpetual preferred shares and allow the Sub to make interest payments due on the notes.

In another embodiment, the invention provides a system and method for structured finance wherein after the Sub suspends interest payments on the notes for the maximum allowable period, the company can redeem all or some of the perpetual preferred shares with proceeds used to make payments due on the notes.

In another embodiment, the invention provides a system and method for structured finance wherein after the Sub suspends interest payments on the notes for the maximum allowable period, the company can remarket all or some of the perpetual preferred shares for par plus accrued and unpaid dividends by resetting the coupon yield and use proceeds to make payments due on the notes.

In another embodiment, the invention provides a system and method for structured finance wherein after the Sub suspends interest payments on the notes and subsequently makes payments of all accrued and unpaid interest on the notes to the investors, the Sub can again suspend interest payments on the notes for a period of time (e.g., up to a maximum of twenty consecutive quarters), provided that payments on all of the company shares and deferrable securities ranking pari passu or junior to the financial guarantee on the notes are likewise suspended.

In another embodiment, the invention provides a system and method for structured finance wherein investors who have not received all accrued and unpaid interest within thirty days of the end of the maximum allowable interest deferral period may accelerate the notes under the junior subordinated financial guarantee.

In another embodiment, the invention provides a system and method for structured finance wherein at maturity of the notes, the company can redeem the perpetual preferred shares with proceeds used by the Sub to repay the notes.

In another embodiment, the invention provides a system and method for structured finance wherein at maturity of the notes, the company can remarket the perpetual preferred shares for par plus accrued and unpaid dividends by resetting the coupon yield and use proceeds to repay the notes.

In another embodiment, the invention provides a system and method for structured finance wherein in the event of a default on the notes, the investors have the ability to pursue rights under the junior subordinated financial guarantee which becomes a junior subordinated claim.

In another embodiment, the invention provides a system and method for structured finance wherein interest payments on the notes are deductible by the company for the US federal income tax purposes.

In another embodiment, the invention provides a system and method for structuring financings wherein the raised financing receives equity credit from the rating agencies.

In another embodiment, the invention provides a system and method for structuring financings wherein the raised financing is treated as mezzanine equity or a liability at company's election under the US Generally Accepted Accounting Principles (“US GAAP”).

In another embodiment, the invention provides a system and method for structured finance wherein notes, perpetual preferred shares and trust certificates may be convertible into the company's common shares by the holders of those instruments.

In another embodiment, the invention provides a system and method for structured finance wherein in the event of the trust certificates are converted into company's common shares, the Trust can convert the notes into company's common shares and deliver those to the holders of the trust certificates.

In another embodiment, the invention provides a system and method for structured finance wherein in the event of the notes are converted into company's common shares, the Sub can convert the perpetual preferred shares into company's common shares and deliver those to the holders of the notes.

The foregoing specific embodiments, objects and advantages of the invention are illustrative of those which can be achieved by the present invention and are not intended to be exhaustive or limiting of the possible advantages that can be realized. Thus, the embodiments, objects and advantages of this invention will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1A illustrates an embodiment of a system to facilitate the structuring of financing with preferred securities according to the invention;

FIG. 1B illustrates an embodiment of a system to facilitate the structuring of financing with preferred securities according to the invention;

FIG. 1C illustrates an embodiment of a system to facilitate the structuring of financing with preferred securities according to the invention;

FIG. 2 illustrates an embodiment according to the invention;

FIG. 3 illustrates steps in an embodiment of a method according to the invention;

FIG. 4 illustrates an embodiment according to the invention;

FIG. 5 illustrates steps in an embodiment of a method according to the invention;

FIG. 6 illustrates a prior method for structuring financings;

FIG. 7 illustrates a prior method for structuring financings; and

FIG. 8 illustrates a prior method for issuing securities.

It is understood that the drawings are for illustration only and are not limiting.

### DETAILED DESCRIPTION OF THE DRAWINGS

In the various embodiments described below, the invention provides structured finance using an entity (“Sub”) that is formed by a company, capitalizing the Sub with equity from the company, purchasing preferred shares from the company by the Sub, issuing notes from the Sub to investors, and providing a financial guarantee for the notes from the company to the investors. The Sub is demonstrated in the accompanying figures as a Limited Liability Company (“LLC”), but the Sub could be a trust, a business trust, a partnership or a number of other legal forms. The financial guarantee is demonstrated in the accompanying figures as a full and unconditional junior subordinated guarantee by the company of interest and principal on the Sub's debt, however, the guarantee could be a financial guarantee of any seniority. The preferred shares are demonstrated in the accompanying figures as cumulative perpetual preferred shares but could be any type of preferred shares.

In one embodiment, the Sub issues notes directly to investors with an associated financial guarantee.

In another embodiment, the invention provides a method for structured finance through the additional use of a trust that issues trust certificates to the investors and purchases notes from the Sub.

Example System

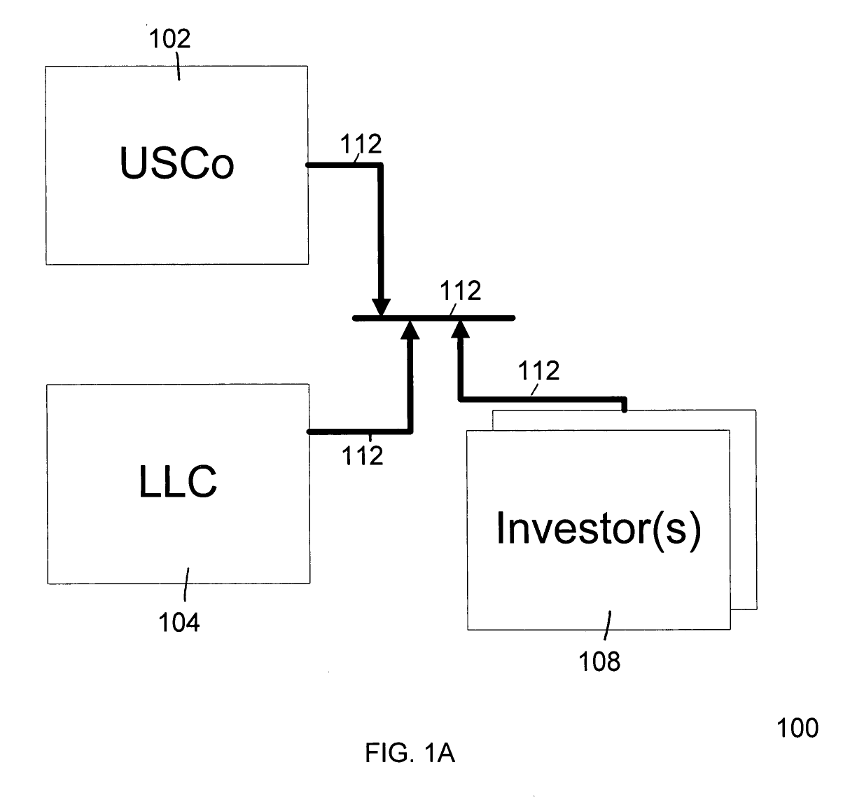

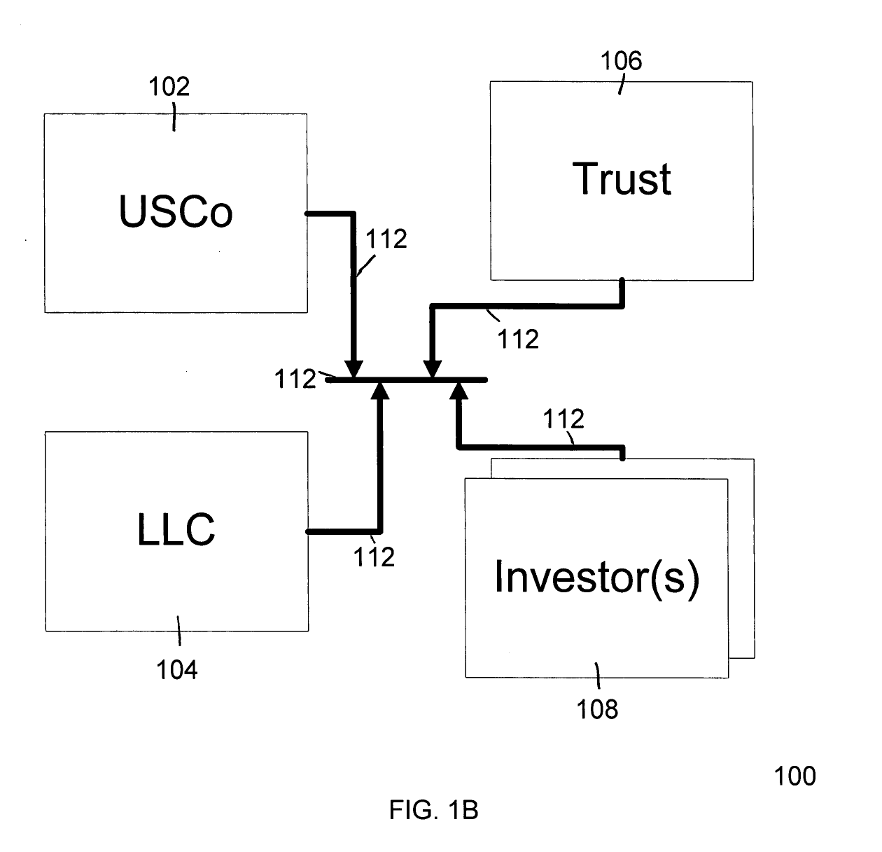

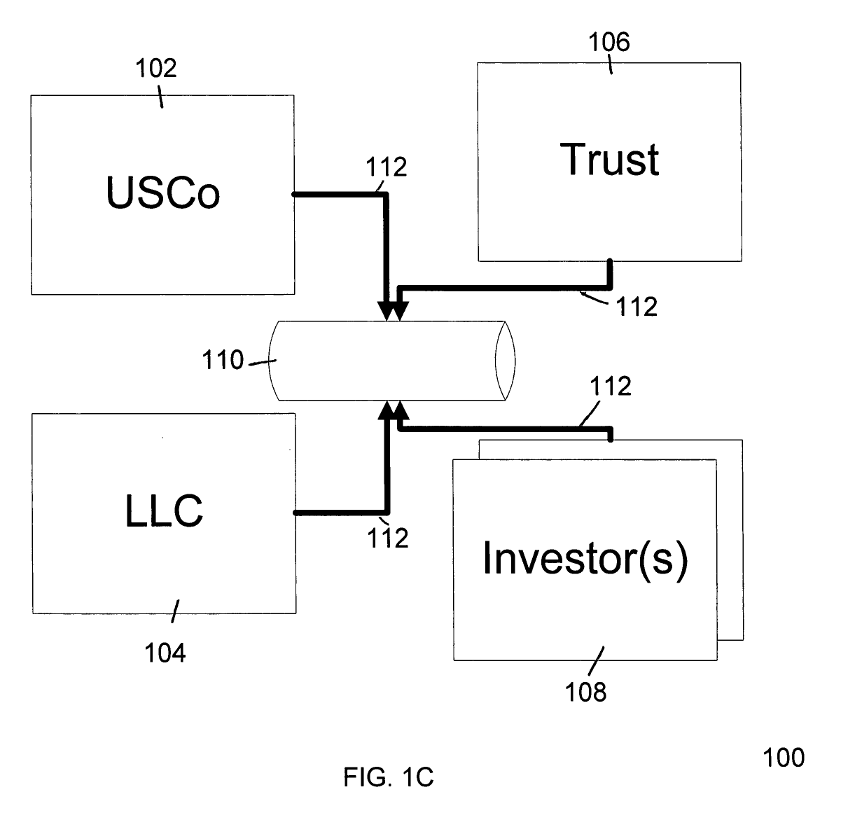

Referring to FIG. 1A, an example embodiment of system 100 includes USCo 102 (e.g., a first party), an entity formed by USCo, LLC 104, and one or more investor(s) 108. USCo 102, LLC 104 and investors 108 are typically interconnected by communications medium 112, which may be a wired, or wireless connection such as a network interface, modem, or other form of I/O, and could be replaced by a manual transfer of data.

Referring to FIG. 1B, another example embodiment of system 100 includes USCo 102 (e.g., a first party), an entity formed by USCo, LLC 104, a Trust 106, and one or more investor(s) 108, also typically interconnected by communications medium 112.

Referring to FIG. 1C, a further example embodiment of system 100 includes USCo 102 (e.g., a first party), an entity formed by USCo, LLC 104, a Trust 106, one or more investor(s) 108, and financial structuring engine 110, all typically interconnected by communications medium 112.

Although not illustrated, USCo 102, LLC 104, trust 106, investors 108 and financial structuring engine 110 each typically include a computer, with a CPU, RAM and ROM memory, I/O and non-volatile data storage, such as a hard disk.

Example Methods

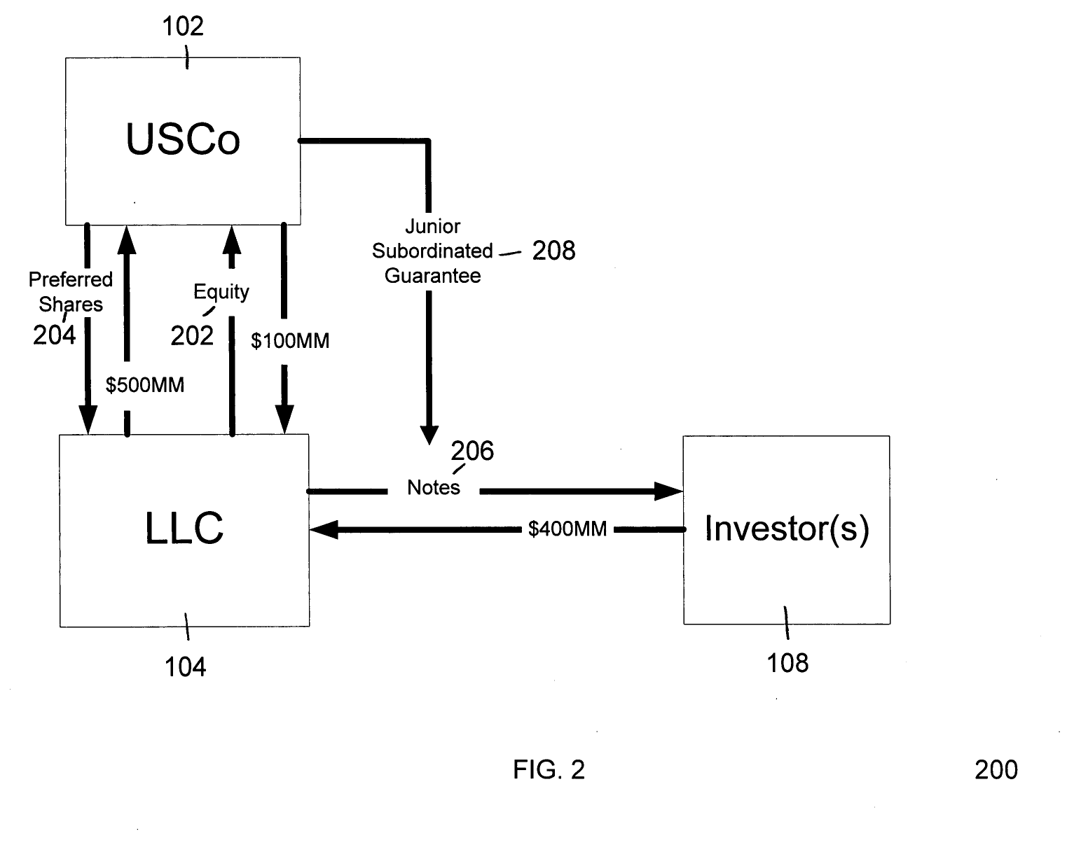

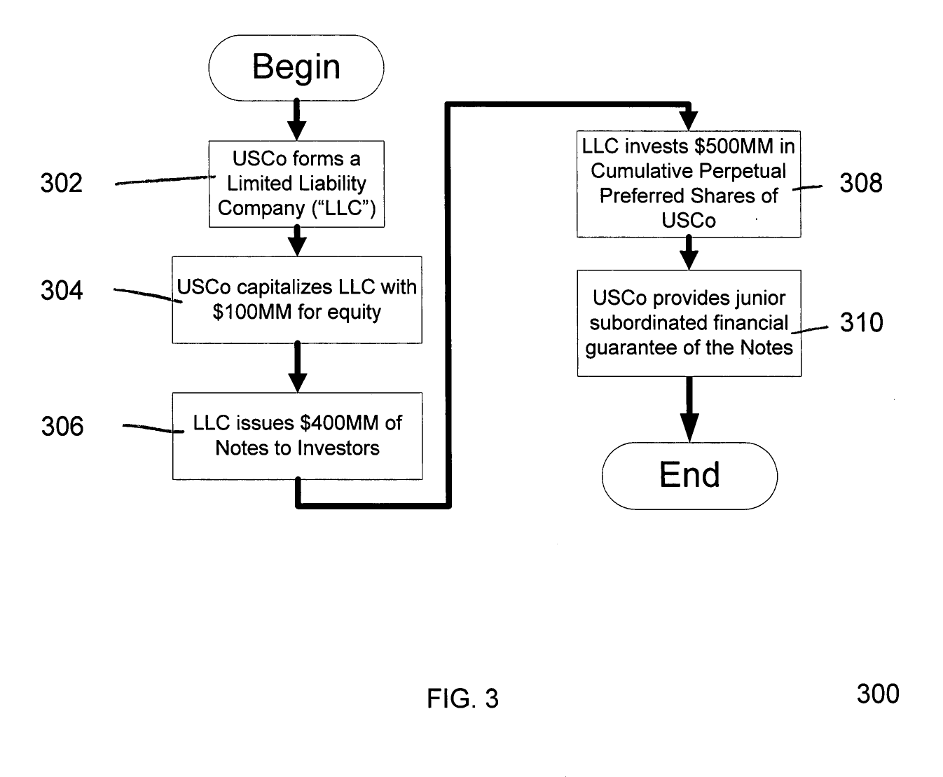

Referring to FIGS. 2 and 3, an example embodiment for a method for structured finance using preferred securities and a financial guarantee is shown. At step 302, USCo 102 forms LLC 104. The LLC 104 is generally formed by USCo 102, but can be formed by another entity.

At step 304, USCo 102 capitalizes the LLC 104 with some value (e.g., $100 million) of equity (202). The amount of capitalization will vary depending on the financial needs of the USCo 102 and the demands of the investors 108.

At step 306, LLC 104 issues notes (206) (e.g., $400 million) for purchase by one or more investors 108. The notes (206) issued by LLC 104 typically range in maturity from 30 to 49 years, but can have shorter maturity. The amount paid by the investors 108 for the notes (206) issued by the LLC 104 can also vary depending on the financial needs of the USCo 102 and the demands of the investors 108.

At step 308, LLC 104 purchases perpetual preferred shares (204), which are issued by the USCo 102. The perpetual preferred shares (204) are generally cumulative perpetual preferred shares. The amount paid for the perpetual preferred shares (204) can vary depending on the financial needs of the USCo 102 and the demands of the investors 108, but is generally equal to the sum of the notes and the equity (e.g., $500 million). The perpetual preferred shares (204) can also be remarketed in certain circumstances.

At step 310, USCo 102 provides a financial guarantee (208) of the notes (206). The financial guarantee (208) is generally a full and unconditional junior subordinated guarantee of the interest and principal payable on the notes (206).

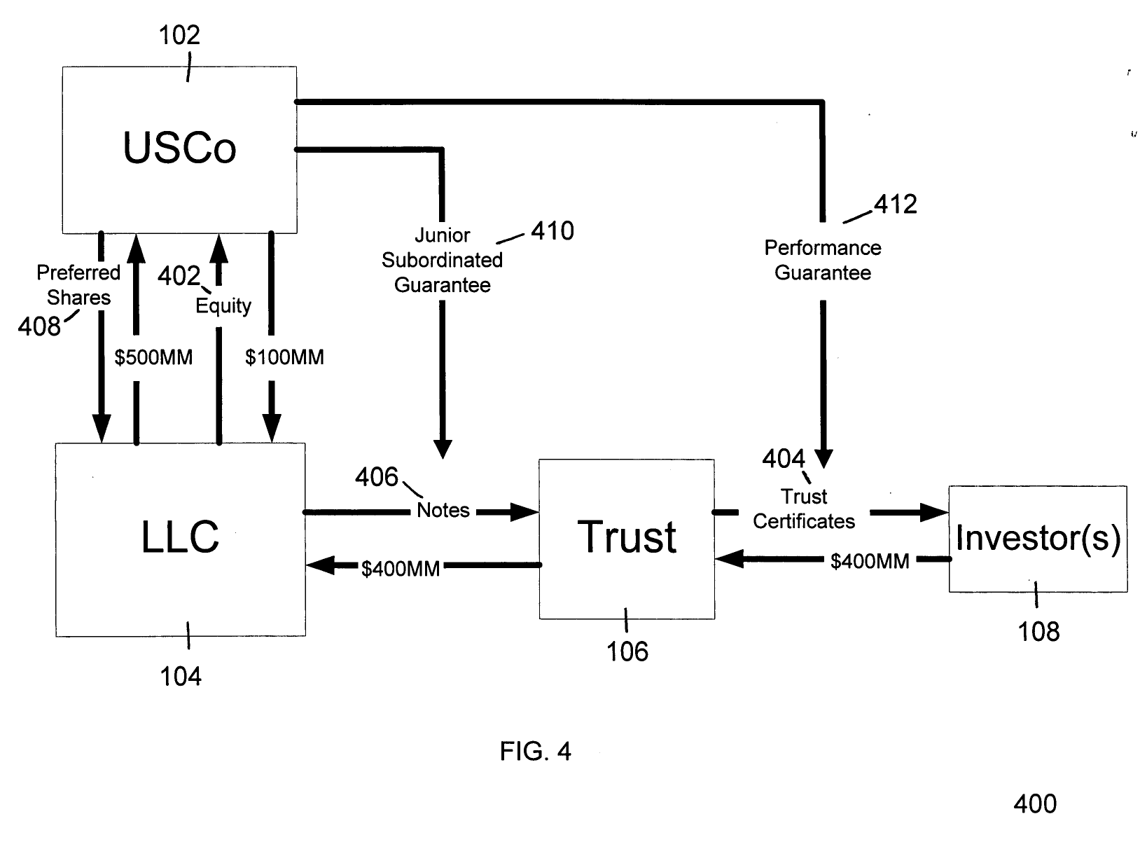

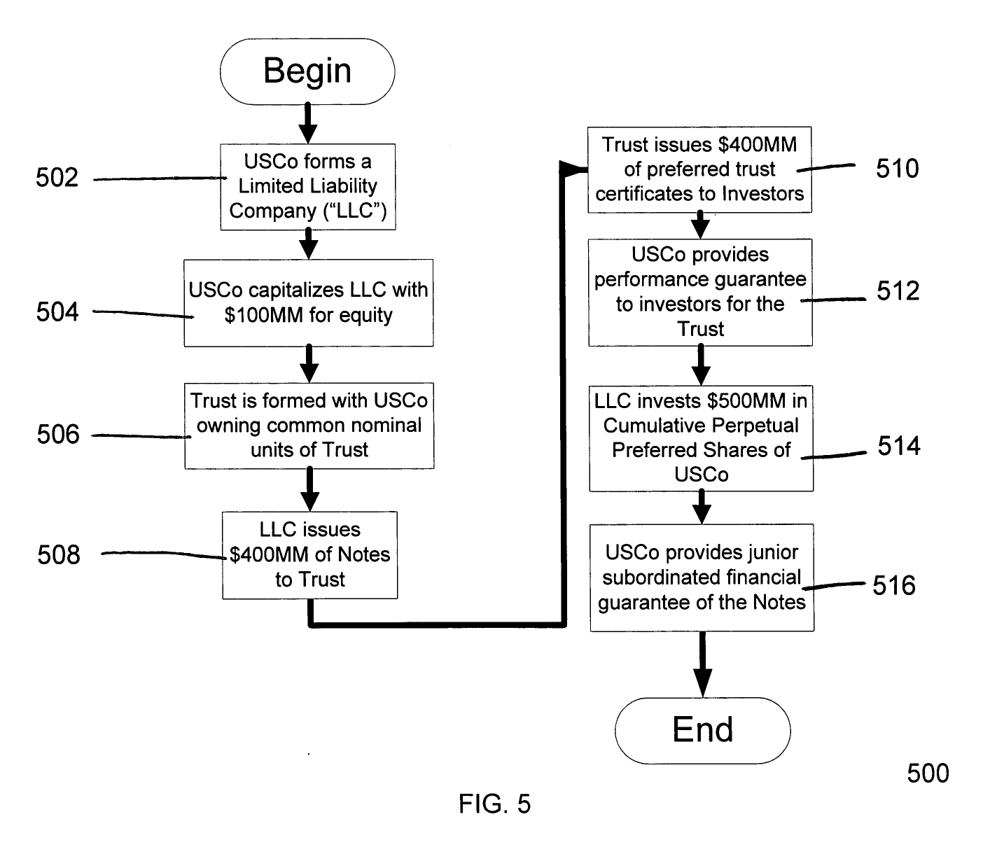

Referring to FIGS. 4 and 5, another embodiment of the invention for structured finance using preferred securities, a financial guarantee, an LLC and a Trust is shown. At step 502, USCo 102 forms LLC 104 and at step 504, USCo 102 capitalizes LLC 104 with equity (402) (e.g., $100 million). As in the earlier example, the LLC is generally formed by the USCo 102, but can be formed by another entity, and the amount of capitalization can vary depending on the financial needs of the USCo 102 and the demands of the investors 108.

At step 506, trust 106 is formed with USCo 102 generally owning common nominal units of the trust 106. The trust 106 can be formed by the USCo 102 or another entity.

At step 508, LLC 104 issues notes to the trust (e.g., $400 million). These notes generally range in maturity from 30 to 49 years, but can have shorter maturity. The amount paid for notes issued by LLC 104 can also vary depending on the financial needs of the USCo 102 and the demands of the investors 108.

At step 510, trust 106 issues trust certificates (404) (e.g., $400 million), which are purchased by one or more investors. These trust certificates (404) are typically preferred trust certificates, but can be common as well. Again, the amount paid for the trust certificates (404) can vary depending on the financial needs of USCo 102 and the demands of investors 108, but generally equal the principal of the notes (406).

At step 512, USCo 102 provides a performance guarantee (412) to the investors 108, which ensures that all funds received by the Trust on the notes will be used to pay distributions on trust certificates (404).

At step 514, LLC 104 then invests in perpetual preferred shares (408) (e.g., $500 million), which are issued by USCo 102. The perpetual preferred shares (408) are generally cumulative perpetual preferred shares. Again, the amount paid for preferred shares (408) is generally equal to the sum of the equity (402) provided by USCo 102 and the investment from investors 108, but can vary depending on the financial needs of the USCo 102 and the demands of the investors 108. The preferred shares (408) can also be remarketed in certain circumstances.

At step 516, USCo 102 provides a financial guarantee (410) of the notes (406). The financial guarantee is generally a full and unconditional junior subordinated guarantee of the amounts payable on the notes (406).

The invention results in a unique combination of accounting and tax results—a financing that can be treated as equity for US GAAP purposes but with payments that are deductible for US federal income tax purposes.

Accounting Interpretation of the Example

In December 2003, a new accounting standard FIN 46(R) was published addressing the framework for consolidating certain types of entities. Under the new standard, an entity is consolidated by the variable interest holder that absorbs the majority of expected losses and/or expected residual returns. Variable interests are defined as “contractual, ownership, or other pecuniary interests in an entity that change with changes in the fair value of the entity's net assets exclusive of variable interests.”

Under FIN 46(R), the voting equity in the Sub is largely irrelevant in determining whether USCo should consolidate the Sub since it is not viewed as a variable interest. Paragraph B7 of FIN 46(R) indicates that if a vehicle's only asset (the perpetual preferred shares) is a contract with (or a security of) its equity investor (USCo), then USCo's equity in the Sub should not be viewed as a variable interest for consolidation purposes. While the financial guarantee is considered a variable interest in the Sub, because a junior subordinated financial guarantee provides only modest additional protection for the investors over preferred shares, it does not have significant value. Ultimately, if USCo goes bankrupt, the difference in recovery rates between preferred shares and junior subordinated claim is much smaller than the investors' expected losses as junior subordinated creditors. As a result, the investors collectively have the majority of expected losses and expected residual returns, so USCo does not consolidate the Sub.

Therefore, the preferred shares issued by USCo to the Sub are recorded as preferred equity on USCo's consolidated balance sheet (generally with a more descriptive label). Dividends on the preferred shares, net of tax, are charged directly to retained earnings and reported in the financing section of the cash flow statement. Earnings per share calculations deduct the after-tax dividends on the preferred shares from net income.

USCo could also at its election treat this financing as a liability, which would allow it to utilize hedge accounting treatment on any swaps against the securities. As a result, dividends on the preferred shares would be considered interest expense and reported in the income statement.

Tax Interpretation of the Example

As mentioned previously, the Sub can be in many forms (e.g., a limited liability company, a trust, a business trust, a partnership or a number of other legal forms) that can be treated as a disregarded entity for US federal income tax purposes. Once the Sub is treated as a disregarded entity, any securities issued by the Sub are treated as securities issued by USCo. Therefore, the the notes issued by the Sub are treated as debt of USCo, making the interest payments on the notes deductible by USCo.

Rating Agency Interpretation of the Example

For credit enhancing features, rating agency treatments using the disclosed embodiments of the invention generally include: an ability to defer payments for a significant period of time (e.g., for up to twenty consecutive quarters); an ability to absorb losses with a guarantee that ranks as a junior subordinated claim in bankruptcy; permanence of capital with a long-dated nature and the USCo's option to remarket the preferred shares at maturity (thus creating a potentially perpetual instrument); and, as applicable, equity accounting treatment.

For equity credit, rating agency treatments using the disclosed embodiments of the invention generally include: grant of approximately 40% equity credit based on the Standard & Poor's hybrid equity scale; and treatment in Basket A or B for Moody Investor Services' depending on the rating of the issuer. Certain structural enhancements (such as (i) allowing redemption of the financing only if it is replaced with an issuance of equal or better equity content securities and (ii) permitting settlement of cumulative unpaid dividends on the preferred shares using only proceeds from the sale of high equity content securities) may allow the invention to may achieve basket B or C classification.

Known Example Methods

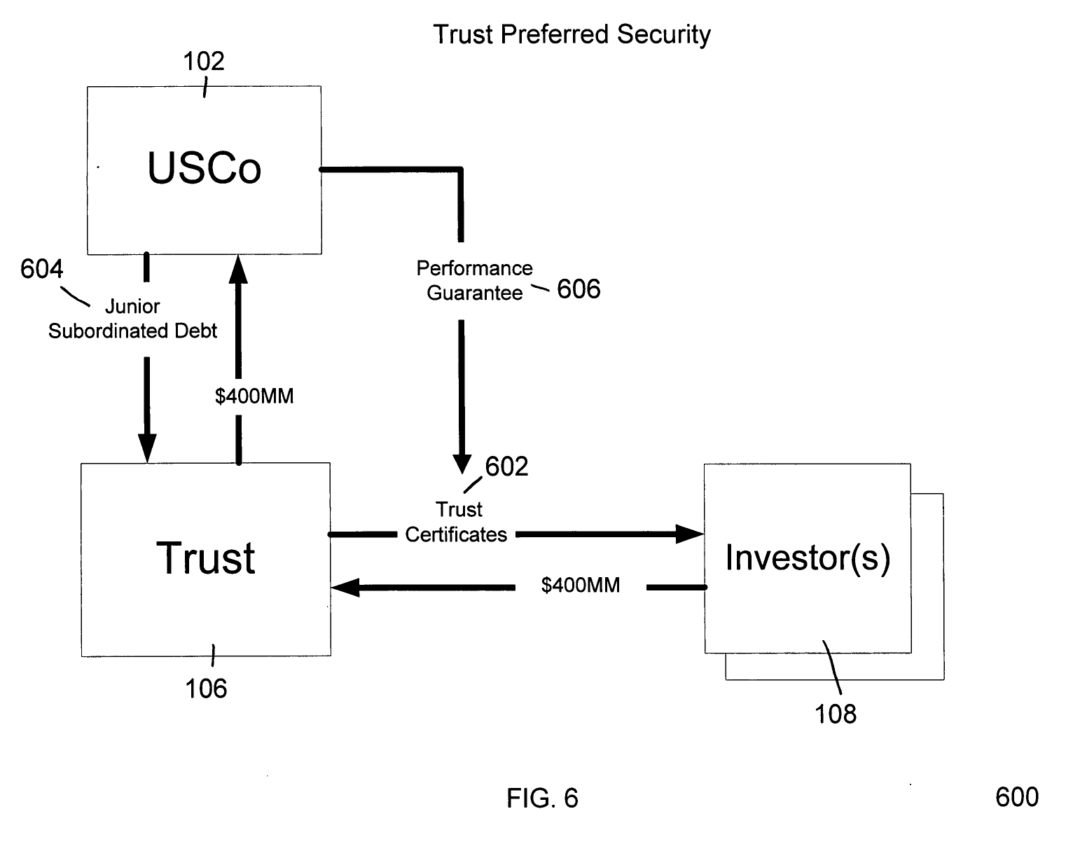

In contrast to the embodiments described above, there are known methods, one of which is illustrated in FIG. 6 and uses trust preferred securities. In the method of FIG. 6, USCo 102 forms a trust 106 and subscribes to nominal common units (generally 3% of capitalization). Trust 106 issues some amount of preferred trust certificates (e.g., $400 million) (602) to investors 108 in return for their investment. Using the funds from the investors, trust 106 invests in junior subordinated debt of USCo (e.g., $400 million) (604) of USCo 102. The junior subordinated debt (604) generally has a tenor of 30+ years with a 5 year interest deferral feature. USCo 102 provides a performance guarantee (606) to investors 108, which ensures that all funds received by the trust 106 from the junior subordinated debt (604) will be used to pay distributions on the trust certificates (602).

The invention differs significantly from the method illustrated in FIG. 6. In a trust preferred securities transaction, the debt and equity roles of USCo and the vehicle are reversed from the invention—a trust issues preferred trust certificates to investors and uses the proceeds to invest in debt of USCo. Prior to recent changes in accounting, the transaction illustrated in FIG. 6 could be recorded on USCo's consolidated balance sheet as mezzanine equity. However, the adoption of FIN 46(R) has resulted in this transaction being treated as debt on USCo's consolidated balance sheet. The new rules resulted in the trust and the Sub involved in these transactions being deconsolidated from USCo. The net effect is that a trust preferred securities transaction results in USCo issuing debt to a non-consolidated trust, while the invention results in USCo issuing perpetual preferred shares to a non-consolidated entity.

One other important difference is the difference in the guarantees used in a trust preferred securities transaction and in the invention. In a trust preferred securities transaction, USCo provides a performance guarantee to investors for the performance of the trust (to the extent that the trust has funds sufficient to make the payments on trust certificates, these payments will be made). However, in one embodiment of the invention, USCo provides a full and unconditional (junior subordinated) financial guarantee of the principle and interest of the notes.

Another example of a known structured transaction is the Reverse MIPS-type structure. There are a few different permutations of Reverse MIPS-type structures, but all have the same basic characteristics and attempt to achieve the same result. The basic concept is that a company, USCo, forms a vehicle, which issues debt, and the funds are used to purchase preferred securities of the USCo. The debt is recourse only to the assets of the vehicle (i.e., preferred securities). One purpose of a Reverse MIPS structures is to create a financing that will allow the USCo to make tax-deductible payments, while recording the transaction for accounting purposes as preferred shares issued to a non-consolidated vehicle.

The Reverse MIPS-type structures now have certain disadvantages. As background, in 1984, the Emerging Issues Task Force issued EITF 84-40, which concluded that in a similar structure the vehicle should be consolidated, and the SEC determined that the transaction should be recorded as debt on USCo's consolidated balance sheet. Nearly a decade later, a new variation of the structure was created in an attempt to deconsolidate the vehicle by using a partnership. However, it is generally believed that no Reverse MIPS transactions were executed due to IRS Notice 94-47, which determined that debt, which was recourse only to preferred shares, was not tax deductible. As a result, the Reverse MIPS transactions disappeared from the market.

While the invention has some similarities to Reverse MIPS-type structure, there are some key differences that make this product unique. The first difference is the use of a “check-the-box” entity for US tax purposes, which allows USCo to treat the Sub as a disregarded entity. These “check-the-box” regulations were only introduced in 1995, one year after IRS Notice 94-47 was issued. As described or known, previous structures have used partnerships or trusts to issue debt. While industry publications have mentioned that the use of a “check the box” entity in Reverse MIPS-type structures may be preferable to partnerships or trusts, no replacement structure was proposed until now. One reason may be that the tax objectives of a Reverse MIPS-type product (i.e., accounting equity product with tax-deductible payments) could still not be achieved until recently. This was assisted with the passage of Financial Accounting Standards Board (“FASB”) accounting rule FIN 46(R), in December 2003.

The second, and most important, difference is the use of a junior subordinated financial guarantee. For certain embodiments, the guarantee is a full and unconditional financial guarantee by USCo of interest and principal on the Sub's notes. This guarantee ensures that the notes is tax-deductible by USCo. For the US federal income tax purposes, the Sub is disregarded, and in light of the guarantee USCo is viewed as issuing junior subordinated, full recourse debt itself. That is clearly not the tax analysis under Reverse MIPS-type structures, as the debt has recourse only to the preferred shares and not USCo.

The key reason that a financial guarantee was not used in Reverse MIPS and similar structures relates to financial accounting. Prior to the passage of FIN 46(R), Consolidation of Variable Interest Entities, in December 2003, USCo would be required to consolidate an entity where it owned the majority of the entity's voting securities and guaranteed its obligations. Thus, using a guarantee to obtain tax deductibility was not a possibility if a company wanted to achieve equity characterization for accounting purposes, as the vehicle would be consolidated and the debt would show up on USCo's consolidated books. With the passage of Fin 46(R), the entire framework for consolidating certain types of entities changed, which allowed for the invention to occur.

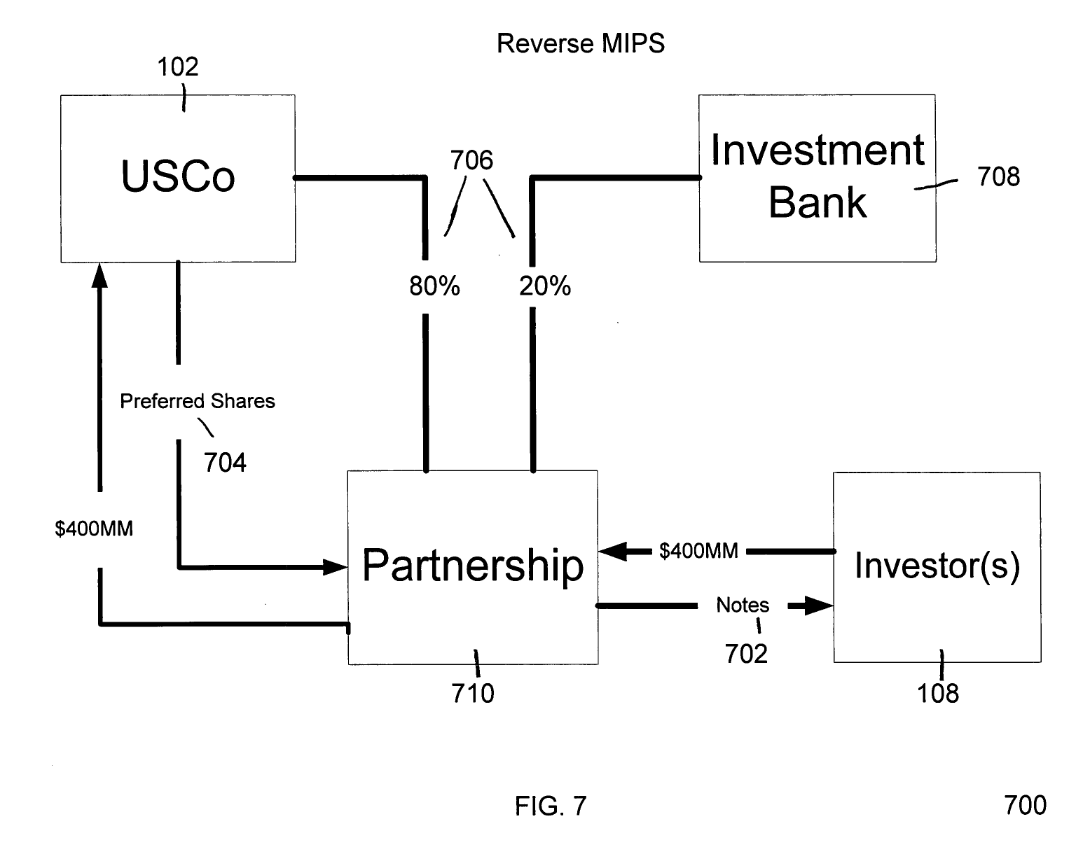

FIG. 7 illustrates an example of a Reverse MIPS structure. In this method, USCo 102 and an investment bank 708 form a partnership (710), with USCo 102 holding a majority (e.g., 80%) general partnership interest (706). The partnership 710 issues 30+ year notes (e.g., $400 million) (702) with a 5 year deferral feature. The partnership 710 then invests in perpetual preferred shares (e.g., $400 million) (704) of USCo 102. The notes 702 have recourse only to the preferred shares 704.

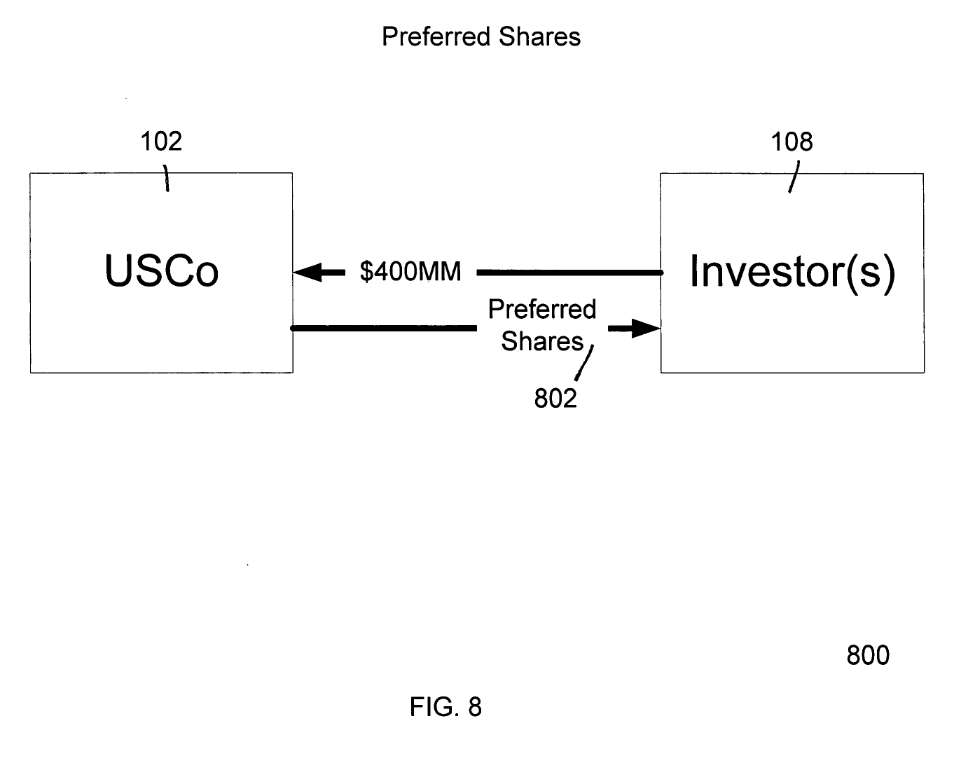

FIG. 8 illustrates another known method for structuring financing with the use of preferred shares. In this method, USCo 102 issues $400 million of preferred shares 802 directly to investors 108. This method differs from the invention, since although the preferred shares 802 are recorded as equity on the consolidated balance sheet of USCo 102, the distributions on the preferred shares 802 are not tax deductible by USCo 102.

Further Embodiments

As a hybrid form of equity capital, the embodiments described above allow a company to raise capital with tax deductible distributions; equity credit from rating agencies; equity accounting treatment; financial flexibility; and attractive pricing. The embodiments also provide an ideal financing transaction for companies that want to raise non-dilutive preferred capital to support strategic initiatives; obtain low-cost balance sheet support during downturns; and refinance debt or other preferred securities.

As described in the embodiments above, the notes generally have a maturity of 49 years, although they can be shorter. The notes also generally have coupons payable quarterly in arrears. The notes can also generally be callable after 5 years at par plus accrued and unpaid interest. The notes can also generally have interest deferred for up to 5 years.

Also as described above, the preferred shares are generally cumulative perpetual preferred shares, and can be callable after 5 years at par plus accrued and unpaid dividends. Further, the shares can be generally remarketed with the dividend yield reset to allow the preferred shares to be sold for par plus accrued and unpaid dividends. Remarketing can generally occur at the earlier of 49 years or the end of a 5 year dividend suspension period.

Also as described above, the guarantee is generally a full and unconditional guarantee of amounts payable on the notes, and ranks as a junior subordinated claim on the company providing the guarantee.

As described above, the payments on the notes generally may be suspended by the Sub up to a maximum of twenty consecutive quarters, provided that dividends on all of the company shares and deferrable securities ranking pari passu or junior to the junior subordinated financial guarantee are likewise suspended.

Also as described above, after the Sub suspends interest payments for up to a maximum of twenty consecutive quarters, the company can generally pay all accrued and unpaid dividends on the cumulative perpetual preferred shares and the Sub generally can use the proceeds to make interest payments on the notes.

As described in the embodiments above, after the Sub suspends interest payments for up to a maximum of twenty consecutive quarters, the company generally can redeem the cumulative perpetual preferred shares with proceeds used to repay the notes.

As described above, after the Sub suspends interest payments for up to a maximum of twenty consecutive quarters, and the Sub subsequently makes payments of all accrued and unpaid interest on the notes to the investors, the Sub may again suspend interest payments on the notes for up to a maximum of twenty consecutive quarters.

As described in the embodiments above, for investors who have not received all accrued and unpaid interest within thirty days of the end of a period of up to twenty consecutive quarters, the investors may generally accelerate the notes under the junior subordinated financial guarantee.

As described above, in the event of a default on the notes, the investors have the ability to pursue rights under the junior subordinated financial guarantee which becomes a junior subordinated claim.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method for structured finance, the method comprising:
forming an entity;
capitalizing the entity with equity;
issuing at least one note from the entity to at least one second party;
the entity purchasing at least one perpetual preferred share issued by a first party; and
providing a financial guarantee of the at least one note, wherein the first party provides the financial guarantee.

2. The method according to claim 1, wherein the entity is formed by the first party.

3. The method according to claim 1, wherein the at least one second party is an investor.

4. The method according to claim 1, wherein the at least one perpetual preferred share has a cumulative dividend feature.

5. The method according to claim 1, wherein the entity is a limited liability company.

6. The method according to claim 1, wherein the entity is a business trust.

7. The method according to claim 1, wherein the entity is a trust.

8. The method according to claim 1, wherein the entity is a partnership.

9. The method according to claim 1, wherein the financial guarantee is a junior subordinated financial guarantee.

10. The method according to claim 9, wherein following a default on the at least one note, the rights under the financial guarantee become a junior subordinated claim.

11. The method according to claim 1, wherein the at least one second party is a trust.

12. The method according to claim 11, wherein the trust issues trust certificates to at least one third party.

13. The method according to claim 12, wherein the at least one third party is an investor.

14. The method according to claim 1, wherein the perpetual preferred shares can be callable after a certain period of time (e.g., five years) at par plus accrued and unpaid dividends.

15. The method according to claim 1, wherein the perpetual preferred shares can be remarketed at certain times for par plus accrued and unpaid dividends by resetting the coupon yield.

16. The method according to claim 1, wherein the maturity of the at least one note is up to forty-nine years.

17. The method according to claim 1, wherein the at least one note is payable periodically (e.g., quarterly) in arrears.

18. The method according to claim 1, wherein the at least one note can be callable after a certain period of time (e.g., five years) at par plus accrued and unpaid interest.

19. The method according to claim 1, wherein dividends on the perpetual preferred shares can be suspended for a certain period of time.

20. The method according to claim 1, wherein the perpetual preferred shares can be redeemed with proceeds used to repay the at least one note.

21. The method according to claim 1, wherein interest payments on the at least one note can be deferred for a certain period of time (e.g., up to twenty quarters).

22. The method according to claim 21, wherein after the interest payments on the at least one note are deferred for a certain period of time (e.g., up to a maximum of twenty consecutive quarters), and all the unpaid interest is not repaid within thirty days of this period, then at least one note may be accelerated under the financial guarantee.

23. The method according to claim 21, wherein after the interest payments on the at least one note are deferred for a certain period of time (e.g., up to a maximum of twenty consecutive quarters), and all accrued and unpaid interest on the notes are subsequently paid, payments on the notes can again be suspended for a certain period of time (e.g., up to a maximum of twenty consecutive quarters).

24. A system for structured finance, the system comprising:
means for forming an entity;
means for capitalizing the entity with equity;
means for issuing at least one note from the entity to at least one second party;
means for the entity to purchase perpetual preferred shares issued by a first party; and
means for providing a financial guarantee of the at least one note, wherein the first party provides the financial guarantee.

25. A programmed computer for structured finance, comprising:
a memory having at least one region for storing computer executable code; and
a processor for executing the program code stored in the memory, wherein the program code comprises:
code to determine timing of interest payments on notes;
code to determine timing of dividend payments on perpetual preferred shares;
code to identify when perpetual preferred shares can be remarketed;
code to keep track of which parties hold notes, perpetual preferred shares, and trust certificates.

26. A programmed computer for structured finance, comprising:
a memory having at least one region for storing computer executable code; and
a processor for executing the program code stored in the memory, wherein the program code comprises:
code to form an entity;
code to capitalize the entity with equity;
code to issue at least one note from the entity to at least one second party;
code to allow the entity to purchase perpetual preferred shares issued by a first party; and
code to provide a financial guarantee of the at least one note, wherein the first party provides the financial guarantee.
